(19) United States
(12) Patent Application Publication
(10) Pub. No.: US 2016/0100566 A1
(43) Pub. Date: Apr. 14, 2016

(54) Bovine Hoofblock with Improved Glue Application, Adhesion, and Design

(71) Applicant: The Smart Block, L.L.C., Clovis, NM (US)

(72) Inventor: Martinus VanBeek, Clovis, NM (US)

(21) Appl. No.: 14/691,346

(22) Filed: Apr. 20, 2015

Related U.S. Application Data
(60) Provisional application No. 61/996,052, filed on Apr. 28, 2014.

(51) Int. Cl. A01L 3/00

(52) U.S. Cl. CPC A01L 3/00

(57) ABSTRACT

A method and apparatus for affixing a hoofblock to the hoof of an animal comprising, providing a hoofblock having a plurality of spacers disposed thereupon; positioning, an animal hoof on the hoofblock where the spacers create a cavity between the animal hoof and the hoofblock. The method continues by injecting an adhesive into the cavity through one or more injection ports disposed within the hoofblock, and affixing the hoofblock to the hoof of the animal by allowing the adhesive to cure, thereby creating a bond between the hoofblock and the animal hoof.

### CROSS-REFERENCE TO RELATED APPLICATIONS

This application claims the benefit of U.S. Prov. Appl. 61/996,052, filed 28 Apr. 2014, which is incorporated herein by reference.

### FIELD OF THE DISCLOSURE

This subject matter of the present disclosure relates to the trimming of dairy cows' hooves, specifically the therapeutic trimming of the hooves of lame cows.

### BACKGROUND OF THE DISCLOSURE

In the art of hoof trimming, bovine cows that have become lame, due to injured hooves, etc., must be trimmed and treated in order to relieve pressure from the wound. This process of trimming is done by applying a block or shoe to the healthy side of the hoof so that the injured side of the hoof is elevated and does not serve as a weight-bearing contact for the cow during the healing time of the injury.

Blocks or shoes have typically been used on cows for years. The purpose of using blocks for lame cows is to lift the injured side of the hoof about ½ an inch to 1 inch off of the ground for a long enough amount of time for the injured side to heal and to be sound enough to bear weight. The first blocks were applied with nails, and later with acrylic glue. However, since the early 1990's, polyurethane glue has become a popular adhesive for applying blocks to cows.

At first, wooden blocks were used to block cows. Wooden blocks typically wear off too fast and fail to provide enough of a yielding surface for cows. This can result in premature loss of the block from the cow's hoof, and additional discomfort on the cow. Thus, conventional wooden blocks generally do not last long enough for a cow's lameness issue to be corrected. Therefore, use of wooden blocks has become less popular since dairy farms have become larger in size and cows have to travel a longer distance on concrete to the milking parlor and back.

Instead of using wood, blocks made from rubber and plastic remedy many of the above issues, provide better shock absorption for the cow, and have otherwise become a better alternative to using wooden blocks on cows. However, even though using rubber or plastic blocks instead of wooden blocks for cows has proven to remedy many of the issues above, there are still many issues that arise using rubber or plastic blocks.

One such problem is that rubber or plastic blocks are typically attached to the cow's claw using glue. Applying glue such as polyurethane is done by putting a layer of glue on top of the block or on the bottom of the hoof after it is flattened and cleaned. Applying glue on the block or the hoof as described above can be performed using tubes or other containers in which glue can be forced or pumped out.

Some of these tubes may also use mixers having mixing elements within, which can be used to mix glue being forced out of the tube before it is applied. Examples of mixers which incorporate mixing elements as discussed above are provided in U.S. Pat. Pub. 2006/0245299. However, one problem with using mixers for mixing glue before the glue is applied is that the glue that remains within the mixers after the glue application is completed is wasted. This is because when the glue that remains within the mixer after application cures, the glue in the mixer, and many times the mixer itself will no longer be able to be reused.

Further, because it is difficult to determine if there is enough glue between the bottom of the hoof and the top of the block after applying the glue, it can be a challenge to know if the glue has been evenly distributed between the two surfaces. One issue related to not knowing if the glue has been evenly distributed, having too much glue increases the curing time and can cause excess glue to leak from the sides. Not only can this be a messy problem for the trimmer, but also an expensive problem since glue is typically expensive. Furthermore, not using enough glue will provide a weaker bond between the cow's claw and the block, which can lead to a block's premature separation from the hoof. When this occurs, the cow has a higher risk of reinjuring the lame hoof, and a new block then has to be reapplied, which means the healing process must start all over again.

Another issue with using some rubber or plastic blocks is that glue, such as polyurethane, is very temperature sensitive. In essence, the warmer the temperature is the faster it cures. As a result, when the glue is applied to a block or directly to the hoof, it is important for the trimmer to set the block in place as quickly as possible.

Sometimes when the glue is first applied to the block and then put on the hoof, the blocks come off prematurely with the glue still on the block. Likewise, it is not uncommon to experience prematurely detached blocks when the glue has been applied to the hoof first. When this happens, the glue is usually still on the hoof while the block has come off. In this case, there is a strong implication that the first surface the glue was applied to holds the stronger bond, and the second surface that the glue was applied to, being the secondary bond, is weaker because the curing process had started with the first surface before the glue was applied to the second surface.

Another problem with using known rubber or plastic blocks is that a cow's hoof is divided into two claws, divided into six zones. The back part or the heel of the hoof consists of a softer tissue, especially the inside of the heel area. Often times, when glue is applied directly to the bottom of the hoof or to a block, the glue enters this area inside the heel area and creates a hard layer in between the inner heel area and the block. This can puncture the soft tissue of the cow's hoof and can lead to further injury and discomfort for the cow.

Thus, there is a need for a system and method for affixing a hoof block to the hooves of cows that eliminates the issues above and other issues that many professional hoof trimmers experience daily. The foregoing summary is not intended to summarize each potential embodiment or every aspect of the present disclosure.

### SUMMARY OF THE DISCLOSURE

A method and apparatus for affixing a hoofblock according to the present disclosure, to the hoof of an animal is disclosed. The method comprising, providing a hoofblock having a plurality of spacers disposed thereupon, and positioning an animal hoof on the hoofblock where the spacers create a cavity between the animal hoof and the hoofblock. The method continues by injecting an adhesive into the cavity through one or more holes disposed within the hoofblock, and affixing the hoofblock to the hoof of the animal by allowing the adhesive to cure, thereby creating a bond between the hoofblock and the animal hoof.

The method further includes providing a hoofblock having a side surface, wherein at least a portion of the side surface comprises an elevated rim that creates a boundary to contain the adhesive within the cavity during adhesive injection.

The method continues by including that the elevated rim forms a capsule; wherein the hoof is positioned for injection when the hoof is pushed into the capsule.

In another aspect of the method, providing a hoofblock comprises providing, a hoofblock wherein at least a portion of the top surface has an elevated heel area; wherein adhesive is prevented from entering the heel area during adhesive injection.

Another aspect of the method includes injecting an adhesive into the cavity through one or more holes forming a Y-shape; wherein one of the one or more holes terminate at the bottom surface of the hoofblock and two of the one or more holes, being connected to the hole terminating or exposed at the bottom surface, terminate at the top surface.

In another aspect, adhesive may be injected into the cavity through one or more holes terminating at the side wall of the hoofblock. In this aspect, the one or more holes may form a Y-shape within the hoofblock, or may directly communicate with one or more holes terminating or exposed at the top surface of the hoofblock.

The method continues in that one of the two holes that terminate at the top surface terminates in the front of the hoofblock, wherein the other of the two holes terminate in the back of the hoofblock.

In another aspect of the method, injecting an adhesive into the cavity further comprises injecting an adhesive into the cavity so that the adhesive is distributed to the front of the hoofblock and the back of the hoofblock at the same time.

In another aspect of the disclosure, a hoofblock kit is provided having one or more of hoofblocks and an adhesive glue. The adhesive glue for the kit can include glue injection applicators, such as an individual syringes and or multi-use cartridges.

The glue within the kit is either be pre-disposed within the syringe or multi-use cartridges, or may later be inserted within either before the glue is injected into the hoofblock.

In another aspect, the kit can contain one or more mixing tips for mixing the glue that is included in the kit. Typically, the mixing tips may have a tubular form and may have mixing chambers for mixing the glue before the glue is injected into the hoofblock. For example, in this aspect the mixing tips may be in the form of a hollow cylindrical tube or have other shapes or forms.

In a further aspect of the disclosure, the mixing tips are either predisposed on the syringes or multi-use cartridges for mixing glue (e.g., the two components of the urethane adhesive) before the glue is injected into the hoofblock. In yet another aspect however, the mixing tips are not predisposed on the applicator, but can be disposed on the applicator before the hoofblock injection process.

In yet another embodiment of the hoofblock and kit, however, mixing chambers are disposed within the hoofblock itself. In this way, waste or loss of glue while using mixing tips may be minimized.

In a preferred embodiment of the disclosure, the hoofblock cavity has a plurality (e.g., 24) of mixing chamber features in order to get a proper mixing of the glue. However, other embodiments requiring more or fewer mixing chambers may be used to obtain mixing of the glue.

As disclosed herein, however, every mixing chamber that is integrated into hoofblock cavity is a glue saver for the end user since the hoofblock cavity is already being filled with glue which eventually forms an anchor to the hoofblock once the glue cures.

Now that aspects of the present disclosure have been briefly summarized, the benefits related to the disclosed aspects of the present disclosure will now be briefly summarized.

In a first benefit, an even layer of glue is dispersed between the bottom of the hoof and the block to a desired thickness, with minimal excess of glue, if any at all. Also the Y shape is filled with glue and forms a mechanical bond. This creates an anchor-like effect with the glue and the block which makes it highly unlikely for the glue and the block to ever separate from each other.

In a second benefit, applying the glue in the way disclosed herein involves a one-step process. The glue is injected into the place where it is ideally supposed to be. The bond between the top and the bottom of the block is the same because the execution of this process ensures even distribution. Both surfaces receive the glue at the same time, so there is not any curing time being wasted on the surface that the glue is applied first. The bond is the first and only bond, which should ensure the strongest achievable bond.

In a third benefit, a recommendation of warming the glue to a temperature range between 85 and 120 degrees Fahrenheit would make the glue easier to dispense and also would enable a faster execution of the “blocking” process.

In a fourth benefit, there is no more guess work on how much glue to use or which surface the glue should be applied to first. Just fill the cavity with glue until it is full, and a successful bond between the block and the hoof with the right thickness of glue between the two surfaces should always be achieved.

In a fifth benefit, the shape of this particular block would effectively address the previously stated “Problem #4”. In other blocks, glue can easily come into the sensitive area where the ball of the heel is of the cow (zone 6). As mentioned, the glue becomes very hard and as the cow walks, it can put undesired and harmful pressure on the ball of the heel. In the new and improved shape of the block, the area of this sensitive spot is elevated to the same height as the spacers on the top of the block that creates the cavity between the bottom of the hoof and the top of the claw. This design prevents the glue from entering that sensitive area. This will give the cow a softer more yielding surface to walk on with the ball of her heel, and will likely prevent the cow from experiencing any further trauma from the applied block.

In a sixth benefit, a cow's natural walk or stand is on both claws with an even weight distribution between the left and right hooves of 50/50. If a cow has an injury on a claw and it has to be elevated off the ground with a block, the cow will typically put all her weight on the healthy claw and as a result strain more to keep her weight off of the lame hoof. The design of this particular block should enable the cow to apply her weight more evenly between her healthy and lame hooves, which should make it possible for her to walk or stand with as much comfort as possible.

The foregoing summary is not intended to summarize each potential embodiment or every aspect of the present disclosure.

### BRIEF DESCRIPTION OF THE DRAWINGS

FIG. 1 illustrates the different zones of a cow's hoof.

FIGS. 2A-2E illustrate a hoofblock according to the present disclosure for the left claw of a cow in perspective, top, side, cross-sectional, and bottom views.

FIG. 3A-3E illustrate a hoofblock according to the present disclosure for the right claw of a cow in perspective, top, side, cross-sectional, and bottom views.

FIG. 4 illustrates an embodiment of a kit having hoofblocks and adhesive according to the present disclosure.

FIGS. 5A-5B illustrates cross-sectional views of the two hoofblocks with mixing features incorporated into the adhesive channels.

### DETAILED DESCRIPTION OF THE DISCLOSURE

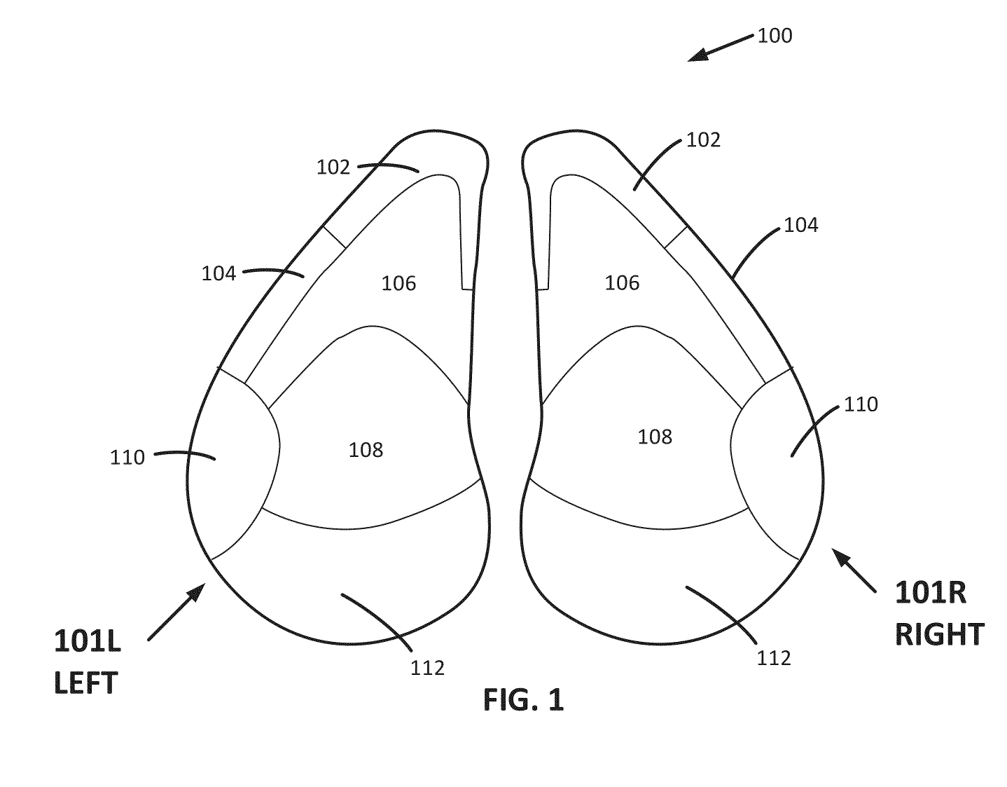

Referring now to the drawings, FIG. 1 illustrates the different zones of a cow's hoof 100, which will be helpful in the discussion of how hoofblocks according to the present disclosure are applied to the cow's hoof 100. The cow's hoof 100 has a left claw (101L) and a right claw (101R), and each claw 101L-R is separated into different zones. For example, referring to the left claw 101L, toward the front or toe of the claw 101L is a toe zone 102, an outer front zone 104, and an inner front zone 106. Additionally, the left claw 101L includes an outer zone 110, an inner zone 108, and a heel zone 112. These zones are mirrored in the right claw 101R of the cow's hoof 100.

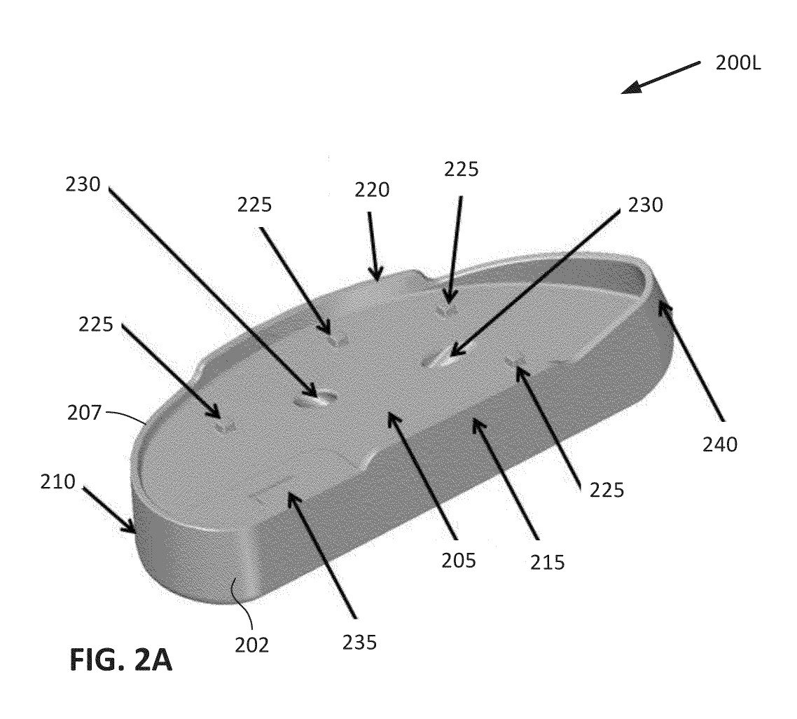

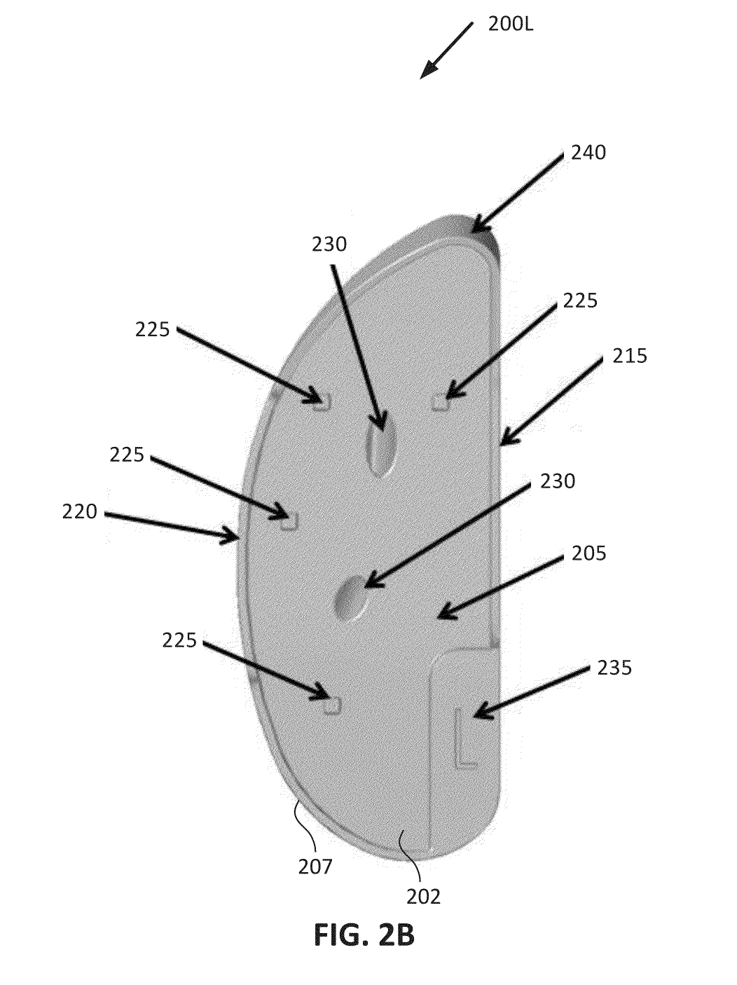

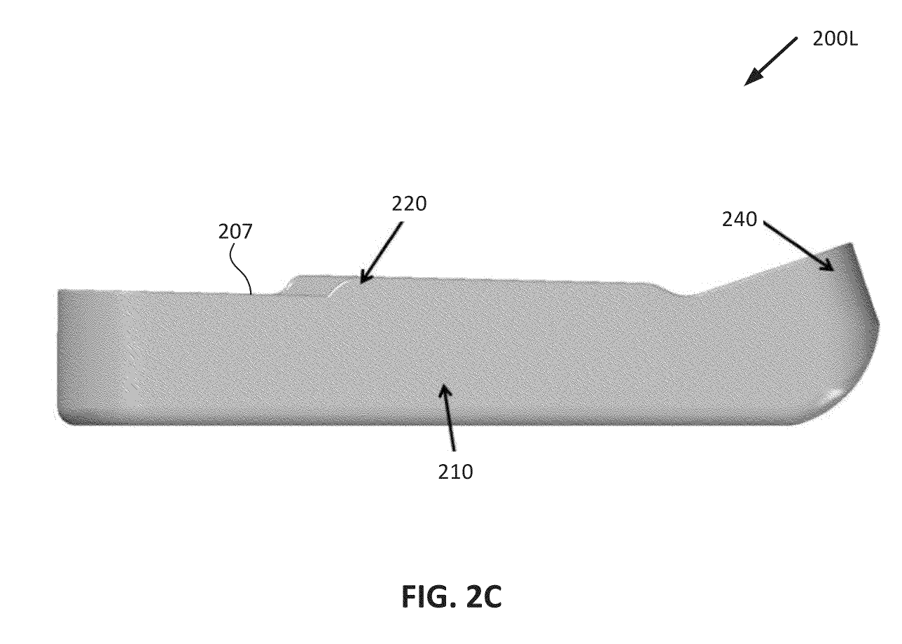

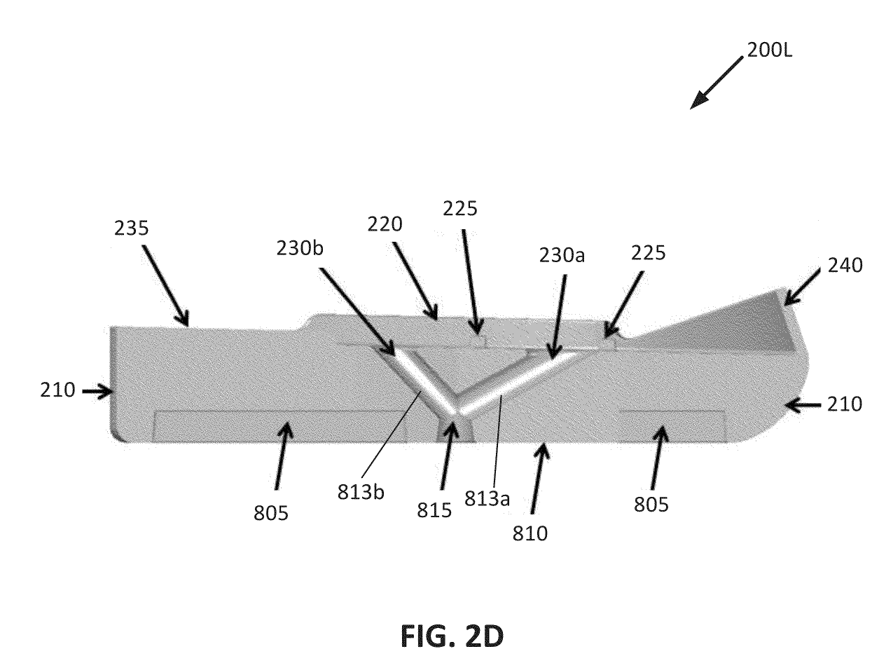

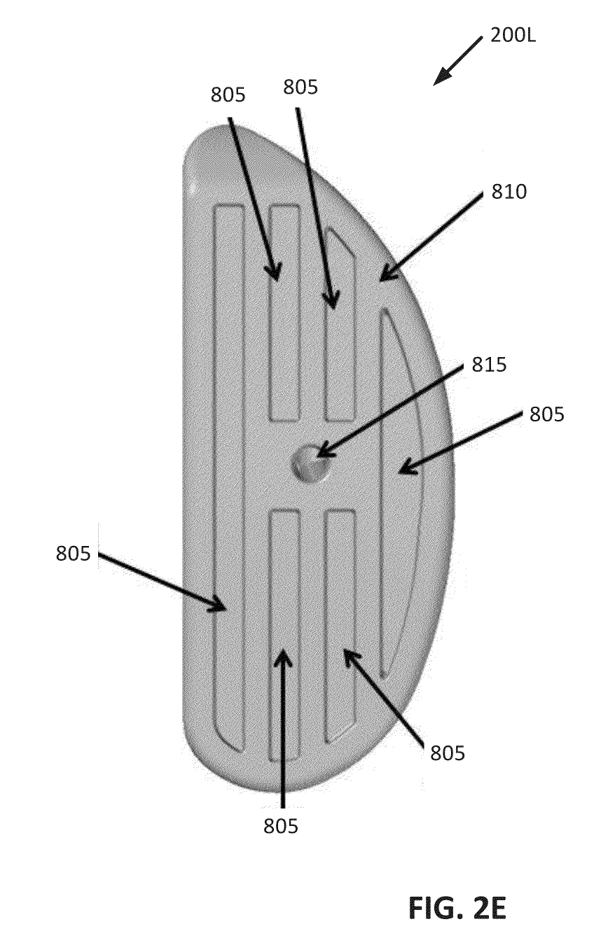

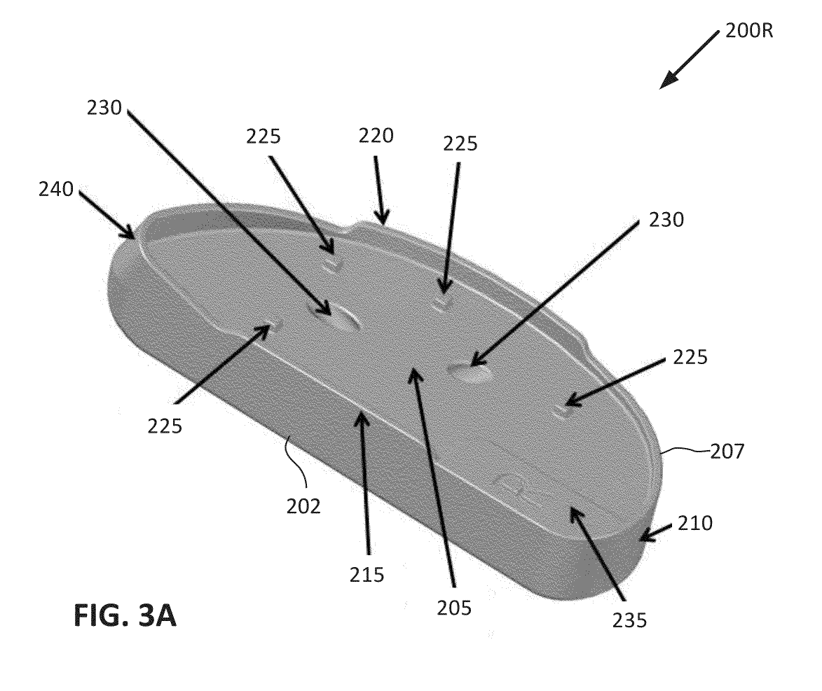

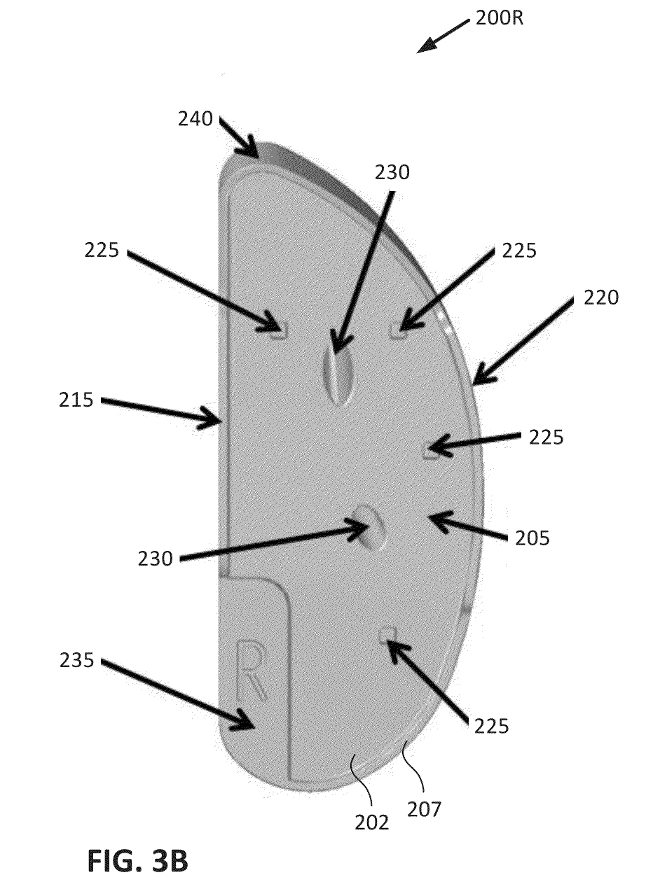

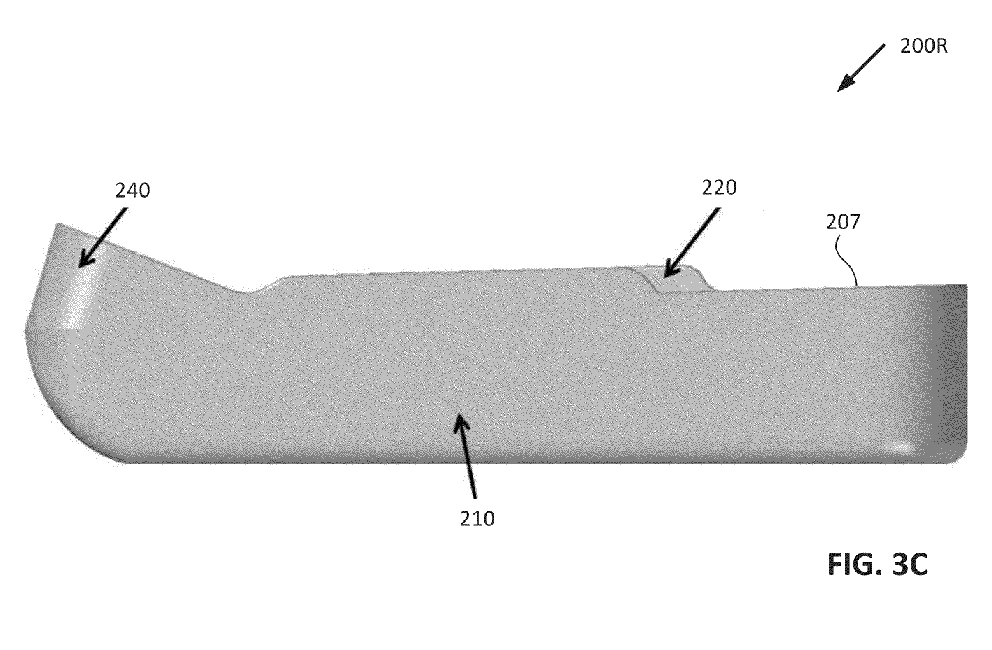

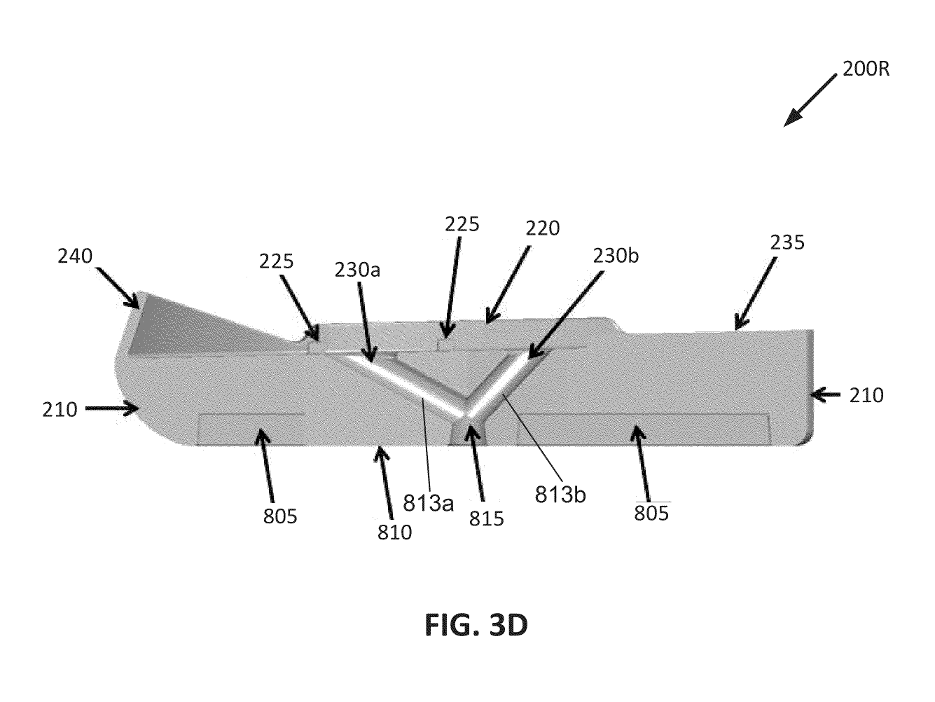

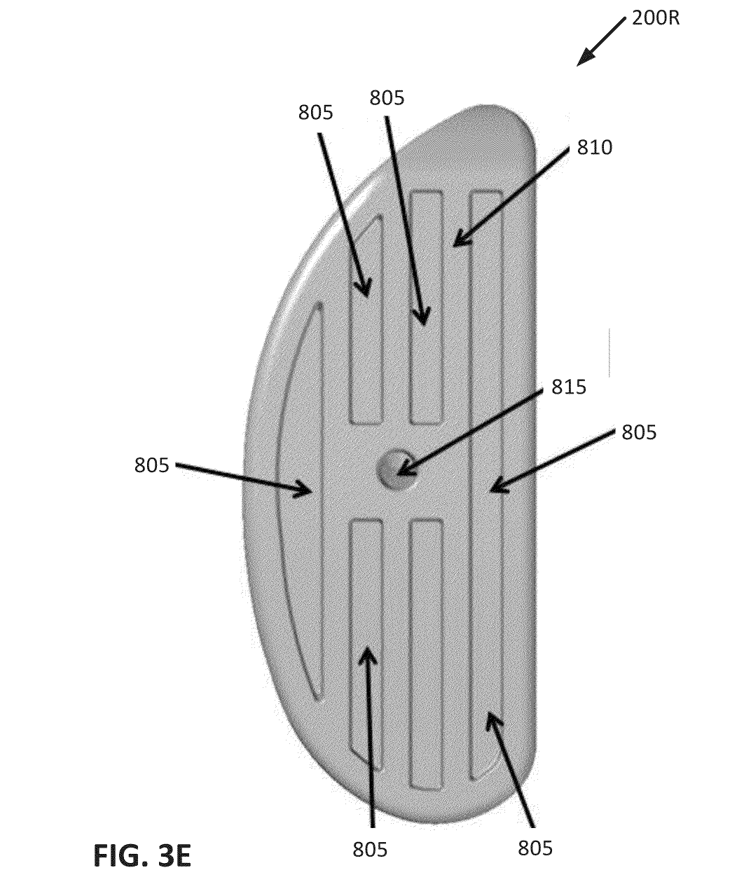

Referring to the illustrations, and in accordance with the present disclosure, a hoofblock 200 as shown in FIGS. 2A through 3E is fitted to a left or a right claw of the hoof 100 of a bovine cow. As described in the present disclosure, the description may at times refer to either the right or left claw 101L-R of the cow's hoof 100 simply as the cow's hoof 100. Furthermore, although the disclosure may describe the disclosed hoofblock 200 as being related to treating the hooves of bovine cows, the disclosed method and apparatus is not limited to the treatment of bovine cow's hooves, and may be used to treat the hooves of other animals.

FIGS. 2A-2E illustrate a hoofblock 200L according to the present disclosure for the left claw 101L of a cow's hoof 100 in perspective, top, side, cross-sectional, and bottom views. By comparison, FIGS. 3A-3E illustrate a hoofblock 200R according to the present disclosure for the right claw 101R of a cow's hoof 100, which is a mirror image of the left hoofblock 200L.

As best shown in FIGS. 2A-2F, the hoofblock 200 includes a block body 202 having a top surface 205 (FIGS. 2B) and a bottom surface 805 (FIG. 2E) separated by a sidewall 210 (FIG. 2C), which extends around the bock body 202.

The top surface 205 of the hoofblock 200 is the surface that will face the bottom of the cow's hoof 100, and the bottom surface 205 of the hoofblock 200 is the surface that will support the cow's hoof 100 on the ground. As illustrated, the sidewall 210 of hoofblock 200 can have a surface with a shape mirroring the outer contour of the left hoof of the cow. In one example, the hoofblock 200 may have different shapes, such as oval, rectangular, trapezoidal, etc., to accommodate differences in the shapes and sizes of cow's hooves. Using this example, the sidewall 210 of the hoofblock 200 may either comprise one continuous side surface, or the sidewall 210 may consist of more than one side surface 210.

As best shown in FIG. 2A, at least a portion of the sidewall 210 contains a thin rim 207 elevated above the top surface 205. The rim 207 may have one or more further elevated rim sections 215, 220, and 240. In a preferred example, the thin rim 207 may have an elevation from 3-mm to ⅛-in. above the top surface 205 of the hoofblock 200. In general, the elevated rim 207 can extend completely around the top surface 205 of the hoofblock 200, can be either part of the sidewall 210 or the top surface 205, or can be disposed thereupon using an adhesive or any other means of fixation known in the art.

In a preferred embodiment, the rim 207 includes an inner boundary 215, an outer boundary 220, and an end capsule 240. The inner boundary 215 situates towards the inside of the cow's hoof 100, while the outer boundary 220 situates toward the outside of the cow's hoof 100. The end capsule 240 is located at the front of the hoofblock 200 and is used to align the hoofblock 200 with the toe zone 102 of the cow's hoof 100 before injection. The elevated rim sections 220 and or 215 may be between 3-mm to 5-mm tall or any height that is necessary for containing an adhesive, such as polyurethane glue, within a cavity formed between the bottom of the hoof 100 and the top of the hoofblock 200, which will be explained further below.

As best shown in FIGS. 2A-2B, the top surface 205 of the hoofblock 200 includes an elevated heel area 235, which is in the area of the heel zone 112 of the cow's hoof 100. The elevated heel area 235 prevents adhesive from being injected inside of the ball area of the heel, thus preventing adhesive from entering in and curing in this area of the cow's hoof 100.

As best shown in FIGS. 2A-2B, the top surface 205 of the hoofblock 200 has a plurality (e.g., two or more) of spacers 225 disposed thereon. In the present example, a number of spacers 225 are situated toward the toe end of the top surface 205 and around the outer side. The number of spacers 225 can be adjusted as well as their distribution on the top surface 205. The spacers 225 create a cavity between the top surface 205 of the hoofblock 200 and the bottom of the cow's hoof 100 when the cow's hoof 100 has been aligned for adhesive injection (discussed further below). In a preferred example, the spacers 225 range between 3-mm and ⅛-in tall. However, the height of the spacers 225 is not limited to this range and may be configured as necessary in order to create a cavity sufficient for adhesive injection.

As best shown in FIGS. 2A-2B, one or more holes 230 are exposed in the top surface 205 of the hoofblock 200. The one or more holes 230 in the top surface 205 of the hoofblock 200 extend as one or more channels through the block body 202 as shown in FIG. 2D to one or more injection ports (i.e., bottom opening or hole 815) in the block's bottom surface (810) as shown in FIG. 2E.

In the side view of the hoofblock 200L in FIG. 2C shows how the thin rim 207 can extend flush with the sidewall 210 above the top surface 205 of the hoofblock 200. As shown, the elevated rim section 220 can extend flush with the sidewall 210 an extent higher than the rim 207. Further as explained above, located in the front of the hoofblock 200, the end capsule 240 used to align the hoofblock 200 with the toe zone 102 of a cow's hoof 100 can be angled inward from the sidewall 210 to give the block 200L a pointed front end. In one example, the elevated rim section 220 at least partially forms the end capsule 240.

Now that the majority of the structural components of the hoofblock 200 have been described, a method according to the present disclosure of affixing a hoofblock 200 to a cow's hoof 100 is disclosed.

Referring now to FIG. 2D, a cross-sectional view of the hoofblock 200L for the left claw 101L of the cow's hoof 100 is illustrated according to the present disclosure. As shown and previously noted above, the hoofblock 200 has the elevated heel area 235 for preventing adhesive from being injected within and curing inside of the ball of the heel of the cow's hoof 100. In a preferred example, the elevated heel area 235 is elevated to the same height as the spacers 225 on the top surface 205 of the hoofblock 200 that create the cavity. Elevating the heel area 235 to this height prevents the glue from entering the sensitive heel area of the cow's hoof 100.

The hoof 100 of a cow is placed on the hoofblock 200 and aligned by pushing the toe zone 102 into the hoofblock's end capsule 240. The spacers 225 disposed on the top surface 205 of the hoofblock 200 then create a cavity or gap between the bottom of the cow's hoof 100 and the top surface 205 of the hoofblock 200.

Preferably, the top surface 205, rim 207, etc. have an associated slope relative to the bottom surface 810 of the block 200L. For example, the top surface 205 may have at least a 2% slope from the back of the hoofblock 200 to the front. This slope can give the cow a better stance and will further promote the healing of the injured hoof 100. Also as shown, the bottom surface 810 of the hoofblock 200 has at least one frictional element or grooves 805 within the bottom surface 810 in order to give the cow a better grip as the cow walks on slippery surfaces.

As already noted above, one or more openings 230 are defined in the top surface 205 of the hoofblock 200 and communicate via channels 813a-b within the block body 202 with one or more injection ports 815 defined in the bottom surface 805 of the hoofblock 200. In the present example, the one or more holes 230 that are open to the top surface 205 of the hoofblock 200 include one hole 230a disposed toward the front of the hoofblock 200L corresponding to the toe zone (102) area of the cow's hoof (100) and include another hole 230b disposed toward the back portion of the hoofblock 200 corresponding to the cow's heel zone (112). This orientation of holes 230a-b allows the injected adhesive to be distributed within the cavity toward both the front and back of the hoofblock 200 at the same time.

Further, the two holes 230a-b in the top surface 205 communicate via Y-channels 813a-b with the one injection port 815 defined at the bottom surface 810 of the hoofblock 200. This allows adhesive injected into the one injection port 815 to split off and be communicated to the front and back portions of the created cavity through the top openings 230a-b.

In another example, there may be one or more holes 230 at the top surface 205 of the hoofblock 200, and one or more injection ports 815 at the bottom surface 810 of the hoofblock 200. Using this example, the holes 820 and 815 being disposed within the hoofblock 200 may be connected to each other in any manner, as long as adhesive can be injected into the cavity between the hoofblock 200 and the cow's hoof 100 using an adhesive injector (applicator 310). Moreover, the injection ports 815 at the bottom surface 810 of the hoofblock 200 may be tapered, so that during the injection process, the applicator (310) or mixing tip (as described below) does not enter into the injection port 815 too far.

After the cow's hoof (100) has been aligned on the top surface 205 as described above, the operator injects an adhesive, such as two-part Polyurethane glue, into the one or more openings or injection ports 815 in the bottom of the hoofblock 200. The adhesive and one or more hoofblocks 200 may be combined within a kit for convenience to avoid compatibility issues between the applicator 310 and the injection port 815, block material, type of glue, etc.

As described above, the injection port 815 can tapered to keep the mixing tip of the glue from entering the bottom opening 815 too far. Because the bottom opening 815 splits into Y-channels 813a-b within the block body 202 to the top openings 230a-b, the adhesive injected into the bottom opening 815 is forced to the top surface 205 in two directions. As a result, one half of the adhesive is distributed to the front of the hoofblock 200, inside the cavity between the bottom of the cow's hoof 100 and the top surface 205 of the hoofblock 200. At the same time, the other half of the glue is distributed to the back half of the hoofblock 200 within the same cavity. This creates an even distribution of adhesive within the cavity.

After curing, the adhesive will create a bond that is not compromised by either surface (i.e., the cow's hoof 100 or hoofblock 200) serving as the first or strongest point of adherence. Because the glue reaches both surfaces at the exact same time, the strongest bond between the two surfaces is ensured. Both surfaces will receive the adhesive at the same time, so curing time will not be wasted on the surface that the adhesive is applied to first. As a result, the bond is the first and only bond, which will ensure the strongest achievable bond.

Furthermore, because both the cavity and the holes 230a-b and 815 extending through the hoofblock 200 are filled with adhesive, when the adhesive cures, the adhesive makes a chemical and or mechanical bond with the hoof 100, and will also anchor the hoof 100 to the hoofblock 200. This anchoring will make it highly unlikely for the glue and the block 200 to ever separate from each other.

In yet another example, in order to make the adhesive injection process faster, the adhesive can be injected at a warmer temperature. The standard recommended temperature for applying adhesive to a hoofblock 200 is between 65 and 75 degrees Fahrenheit. However, in a preferred example of the present disclosure, it is recommended to heat the adhesive to a temperature range of 75 to 105 degrees Fahrenheit. This will make the adhesive easier to dispense and after the adhesive cures, will create a bond that would require less time to set. Furthermore in another example, it is preferred to use a two component fast setting urethane adhesive that is designed for use in applying hoofblocks 200.

For example, the preferred polyurethane adhesive is a component fast setting (30-40 seconds) urethane adhesive designed for use in applying hoofblocks 200 as an adjunct in the treatment of bovine lameness. The preferred polyurethane glue is called 2 part urethane adhesive. The hazardous ingredients are diphenylmethane diisocyanate (MDI) 40-70% and diphenylmethanediisoyanate prepolymer 15-40%.

As already noted above, the top of the block 200 has the thin rim 207 around the outside which in one example preferably ranges between about 1-mm to 5-mm or about 2.5-mm to about ⅛-in tall. This thin rim 207 serves to keep the adhesive from leaking or oozing out the sides of the cavity, and instead contains the adhesive within the cavity between the bottom of the hoof 100 and the top of the hoofblock 200.

As described above, the top surface 205 faces the bottom of the hoof when the hoof 100 is positioned on the hoofblock 200, and in one example has four spacers disposed thereon ranging from 3 mm to ⅛″ tall. Moreover, this range of 3 mm to ⅛″ is the preferred level of glue that should be between the hoof 100 and the top surface 205 of hoofblock 200 to obtain a good bond. However, in other examples, the spacers 225 and/or level of adhesive can vary in height from 1-mm or 3/64-in. to 5-mm or 13/64-in.

In another example, the spacers 225 can be disposed on the top surface 205 of the hoofblock 200 in any arrangement. However, in one example of the present disclosure, one spacer 225 is disposed on the inside of the hoofblock 200 closest to the elevated rim 215 on the inside of the block (or the axial wall). Using this example, two more spacers 225 are disposed closest to the elevated rim 220 on the outside wall (or abaxial wall), and one spacer 225 is disposed close to the outside wall towards the heel.

As best shown in the bottom view of FIG. 2E, one or more grooves 805 or friction members can be disposed on the bottom surface 810 of the hoofblock 200 to give the cow a better grip on slippery surfaces. Also as shown, the hole or injection port 815 for glue injection at the bottom surface 810 of the hoofblock 200 can be centrally located.

Furthermore, although the above disclosure has described that the spacers 225 are rectangular extensions that create a cavity between the top surface 205 of the hoofblock 200 and the bottom of the cow's hoof 100, the spacers 225 may have different structures and or designs. For example, the spacers 225 may be tabs or spikes, or may be cylindrically, rectangular, or even spherically shaped. Further, the disclosed spacers 225 may be extended or elongated ribs, elevated channels, or walls extending some length.

Therefore, in the above examples, the spacers 225 are not limited to being a particular elevated point of isolation on the surface of the hoofblock 200.

In another aspect, the spacers 225 can be removable and can be easily repositioned on the surface of the hoofblock 200. In this arrangement, the top surface 205 of the hoofblock 200 may have isolated locations or channels that allow the spacers 225 to be positioned and repositioned as desired. For example, the spacers 225 may be threaded on one end for being screwed into position along a particular channel or at an isolated location.

In another aspect, the spacers 225 may have some connection mechanism in which the spacers 225 can be connected at any position on the surface of the hoofblock 200. The connection mechanism can be any mechanism in the art for allowing two or more sides of a material or object to be connected with each other. For example, the connection mechanism may have male and female connectors for being disposed on either of the spacers 225 and the surface of the hoofblock 200. The above examples are not limitations, as there are many other ways in which the spacers 225 may be positioned on and/or connected to the surface 205 of the hoofblock 200 for creating the cavity between the top surface 205 and the bottom of the cow's hoof 100.

Moreover, in yet another aspect of the present disclosure, one or more of the injection ports 815 can be disposed along the sidewall 210 of the hoofblock 200 rather than at the bottom. The one or more injection ports 815 in this aspect may communicate directly with a channel, such as the Y-channels 813a-b described in FIG. 2D, within the block body 202 to one of the top openings 230a-b. As a result, the adhesive may be injected into the one or more injection ports 815 and distributed directly to either the back half or front half of the hoofblock 200 depending on which of the top openings 230a-b the injection port 815 has been connected.

In this manner, adhesive may be independently applied to either the front half or back half of the hoofblock 200 when necessary. As a result, depending on the curing times of the adhesive, the one or more injection ports 815 may be used to inject the adhesive into a specific section of the hoofblock 200.

In an aspect of the disclosure above, the one or more injection ports 815 can be tapered in order to keep the mixing tip of the glue from entering the injection ports 815 too far. Also, similar to the description above regarding FIG. 2D the one or more injection ports 815 may split into the Y-channels 813a-b within the block body 202 to the top openings 230a-b so that, when the adhesive is injected into the injection ports 815, the adhesive is forced to the top surface 205 toward the front of the hoofblock 200 and the back half of the hoofblock 200 within the cavity, thus creating an even distribution of adhesive within the cavity.

In yet another aspect of the disclosure, one or more of the injection ports 815, openings 230a-b, and channels 813a-b may be sealed. For example, any of the above ports 815, openings 230a-b, and channels 813a-b may be sealed by selectively disposing an adhesive barrier and allowing the adhesive barrier to cure before or after the injection process. In this example, to form an adhesive barrier, an amount of adhesive may be disposed and allowed to cure within any of the above ports 815, openings 230a-b, and channels 813a-b.

In one aspect of the disclosure, sealing one or more of the ports 815, openings 230a-b, and channels 813a-b before injection of the adhesive may be necessary in order to further control the direction and or flow of the injected adhesive. Moreover, sealing after the injection process may be used to contain the adhesive within the hoofblock 200 depending on the viscosity of the particular adhesive that is injected.

In one example, any of the ports 815, openings 230a-b, and channels 813a-b may be sealed using a sealing agent (not shown), such as a plug or stopper. In the above aspect, the sealing agent may be in a shape that is suitable for sealing the specific port 815, opening 230a-b, or channel 813a-b that the agent is intended to seal. However, the sealing agent may be a shapeable material such as an epoxy, polymer, plastic, etc. that can be shaped to fit the specific port 815, opening 230a-b, or channel 813a-b that the agent is intended to seal.

According to the above aspect, the shapeable material may harden into a non-shapeable material subsequent to being shaped and disposed within the specific port 815, opening 230a-b, or channel 813a-b. Yet, both an adhesive barrier and a sealing agent may be used in combination for sealing and can be disposed within the port 815, opening 230a-b, or channel 813-b before or after the injection process in order to create a seal or barrier.

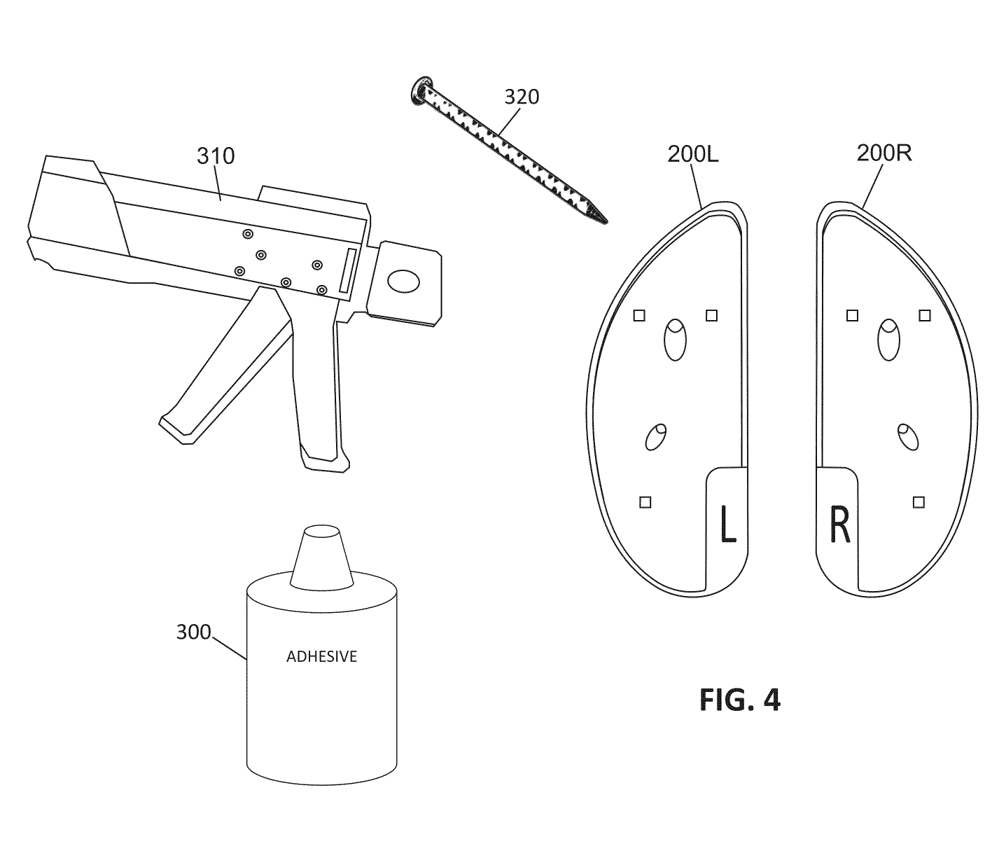

As shown now in FIG. 4, a kit may be provided that includes one or more hoofblocks 200L-R and adhesive 300 as disclosed above. Further, the kit may also include one or more glue injection applicators 310, such as syringes or multi-use cartridges. In yet another aspect, the kit may further contain one or more mixing tips 320 for mixing the adhesive included in the kit.

The mixing tips 320 can be longitudinal tubular structures that contain mixing feature that are used to mix the adhesive before the adhesive is injected into the hoofblock 200L-R through the one or more injection ports (815). As disclosed above, the mixing features within the mixing tips 320 serve to mix the adhesive before the adhesive is injected into the hoofblock 200 during the injection process.

As will be appreciated by those skilled in the art, applicators 310, and mixing tips 320 that include chambers or elements within that are used for mixing adhesives are not limited to the above examples, and can include other designs known in the art.

Moreover in one aspect of the disclosure, the mixing tips 320 disclosed above are part of, or pre-attached to the applicators 310 (i.e., the syringes and or multi-use cartridges). However in another aspect, the mixing tips 320 are not part of or pre-attached to the applicators 310, but can be attached to the applicator 310 before the adhesive is injected into the hoofblock 200 by any attachment means known in the art such as being screwed on or having a snap and or lock components, etc.

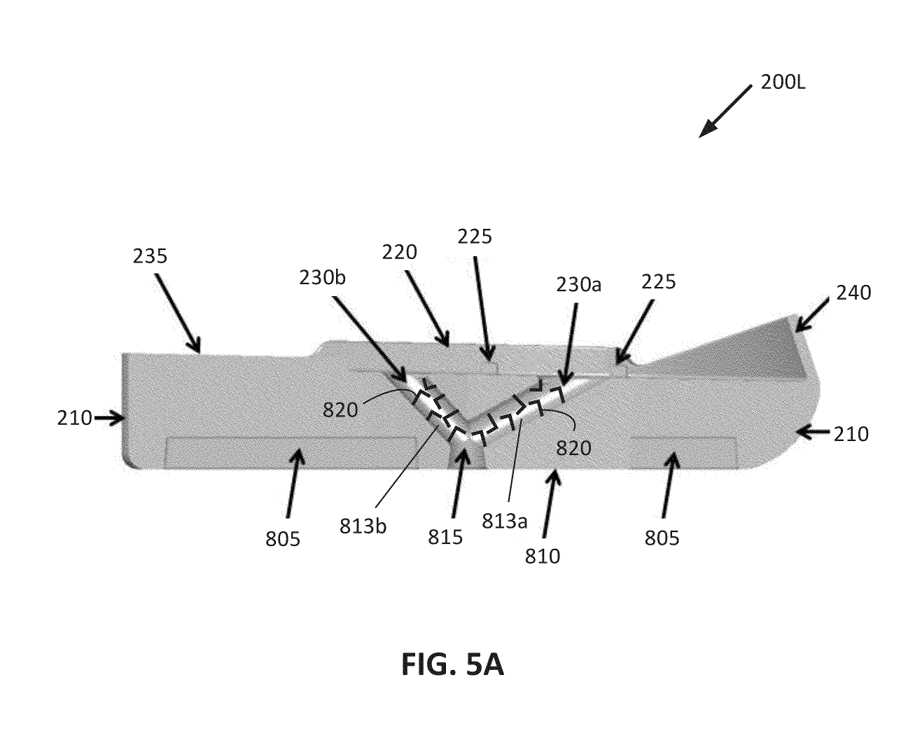

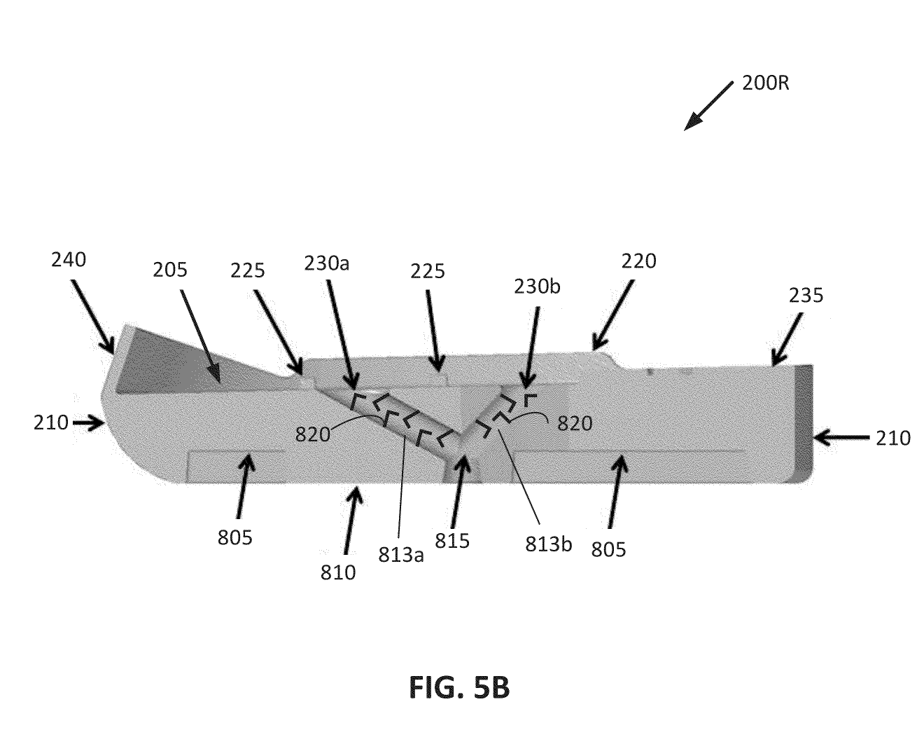

Referring now to the modified cross sectional views in FIGS. 5A-5B, the one or more channels 813a-b in the hoofblock 200 connected to the injection port(s) 815 incorporate mixing chambers therein having mixing features 820 defined in the channels 813a-b.

In one example, the mixing chamber features 820 can include a plurality of chambers, extensions, and/or deflectors within the channels 230a-b that serve to mix the adhesive as the adhesive flows through the channels 813a-b. In an aspect, the mixing chamber features 820 may extend perpendicularly from the inside of the channels 813-b, and can extend from two or more sides within the inner circumference of the channels 813a-b. In another example, the mixing chamber features extend from the inside of the channels 813a-b at an angle, and may be slightly offset from the other mixing chamber features 820 within the channels 813a-b.

By incorporating the mixing chamber features 820 within the hoofblock's channels 813a-b, wasted or lost glue within a mixing tip 320 may be minimized. In other words, because the adhesive is injected directly from the applicator 310 into the hoofblock 200 through the injection port 815, and not first through a mixing tip 320, glue that would potentially remain inside the mixing tip 320 after injection would not be wasted.

In the above example, the mixing chamber features 820 may be disposed entirely throughout the channels 813a-b within the hoofblock 200, although the mixing chamber features 820 may be only partially disposed, being disposed entirely throughout less than all of the channels 813a-b, or be only partially disposed in only one or more specific sections of the channels 813a-b. The feature 820 can take any suitable form known in the art and commonly used in mixing the flow of adhesive glues and the like.

In a preferred embodiment, the hoofblock 200 includes at least twenty-four (24) mixing chamber features 820 within the channels 813a-b in order to ensure a proper mixing of the adhesive. However, other embodiments may also be used requiring fewer than, or more than, twenty-four mixing chamber features 820. In any event, every mixing chamber feature 820 that is integrated into the hoofblock channel 813a-b can help to minimize wasted glue during the hoofblock glue injection process, since the hoofblock channels 813a-b are filled with glue which will eventually forms an anchor to the hoofblock 200 once the glue cures.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method of attaching a hoofblock to an animal hoof with an adhesive, the method comprising:
positioning a top surface of the hoofblock adjacent the animal hoof;
creating a cavity between the animal hoof and the top surface of the hoofblock;
injecting the adhesive into the cavity through at least one channel defined in the hoofblock; and
affixing the hoofblock to the animal hoof by allowing the adhesive to cure, thereby creating a bond between the hoofblock and the animal hoof.

2. The method of claim 1, wherein creating the cavity between the animal hoof and the top surface of the hoofblock comprises at least partially containing the adhesive within the cavity using a rim disposed on at least a portion of the hoofblock.

3. The method of claim 2, wherein positioning the top surface of the hoofblock adjacent the animal hoof comprises pushing a toe of the hoof into a capsule formed by the rim.

4. The method of claim 1, wherein creating the cavity between the animal hoof and the top surface of the hoofblock comprises spacing the top surface from the animal hoof with one or more spacers disposed on the top surface.

5. The method of claim 1, wherein injecting the adhesive into the cavity through the at least one channel defined in the hoofblock comprises preventing communication of the adhesive in the cavity from entering a heel area of the animal hoof using an elevated area on the hoofblock.

6. The method of claim 1, wherein injecting the adhesive into the cavity through the at least one channel disposed in the hoofblock comprises injecting the adhesive into an injection port at a bottom of the hoofblock and communicating the injected adhesive to the cavity through the at least one channel to one or more openings at the top surface of the hoofblock.

7. The method of claim 6, wherein one of the two top openings at the top surface terminate toward a front of the hoofblock, and wherein the other of the two top openings at the top surface terminate toward a back of the hoofblock.

8. The method of claim 1, wherein injecting the adhesive into the cavity further comprises injecting the adhesive into the cavity so that the adhesive is distributed to the front of the hoofblock and the back of the hoofblock at a same time.

9. The method of claim 1, wherein injecting the adhesive into the cavity through the at least one channel disposed in the hoofblock further comprises mixing the adhesive with one or more features disposed in the at least one channel.

10. A hoofblock for affixing to an animal hoof with an adhesive, the hoofblock comprising:
a body having a top surface and a bottom surface, the top surface positioning adjacent the hoofblock and creating a cavity therewith; and
at least one channel defined in the body and communicating from at least one injection port on the body to one or more cavity openings on the top surface, the at least one channel communicating the adhesive into the cavity between the top surface of the hoofblock and the animal hoof.

11. The hoofblock of claim 10, wherein the top surface comprises one or more spacers disposed thereon and spacing the top surface of the body from the animal hoof.

12. The hoofblock of claim 11, wherein the one or more spacers comprise a plurality of one or more tabs, spikes, ribs, elevated channels, or walls distributed on the top surface and extending therefrom.

13. The hoofblock of claim 10, wherein the top surface angles relative to the bottom surface from a back end of the body toward a front end of the body.

14. The hoofblock of claim 10, wherein at least a portion of the top surface comprises a rim elevated from the top surface and creating a boundary at least partially containing the adhesive within the cavity.

15. The hoofblock of claim 14, wherein the rim forms a capsule toward a front end of the body, the capsule receiving a toe portion of the animal hoof therein.

16. The hoofblock of claim 10, wherein at least a portion of the top surface comprises an elevated area disposed thereon, the elevated area preventing a portion of the adhesive in the cavity from entering near a heel of the animal hoof.

17. The hoofblock of claim 10, wherein the at least one channel defined in the body forms a split channel, the split channel having the injection port in the bottom surface of the hoofblock and having two of the one or more cavity openings at the top surface.

18. The hoofblock of claim 17, wherein one of the two cavity openings terminates toward a front end of the hoofblock, and wherein the other of the two cavity openings terminate toward a back end of the hoofblock.

19. The hoofblock of claim 10, wherein the at least one channel comprises one or more features disposed in the at least one channel and mixing the adhesive passing through the at least one channel.

20. A hoofblock kit for treating an animal hoof, the kit comprising:
a container of adhesive; and
at least one hoofblock for affixing to the animal hoof with the adhesive, the at least one hoofblock comprising:
a body have a top surface and a bottom surface, the top surface positioning adjacent the hoofblock and creating a cavity therewith; and
at least one channel defined in the body and communicating from at least one injection port on the body to one or more cavity openings on the top surface, the at least one channel communicating the adhesive into the cavity between the top surface of the hoofblock and the animal hoof.

21. The kit of claim 20, further comprising one or more mixing tips configured to mix the adhesive from the container to the at least one injection port.

22. The kit of claim 20, further comprising an applicator configured to inject the adhesive from the container to the at least one injection port.
